(19) United States
(12) Patent Application Publication
(10) Pub. No.: US 2018/0040862 A1
(43) Pub. Date: Feb. 8, 2018

(54) BATTERY PACK

(71) Applicant: SAMSUNG SDI CO., LTD., Yongin-si (KR)

(72) Inventor: Sangil YI, Yongin-si (KR)

(21) Appl. No.: 15/618,627

(22) Filed: Jun. 9, 2017

(30) Foreign Application Priority Data
Aug. 3, 2016 (KR) 10-2016-0099081

(51) Int. Cl. H01M 2/10; H01M 10/42; H01M 2/20

(52) U.S. Cl. CPC H01M 2/105; H01M 2/204; H01M 10/425

(57) ABSTRACT

A battery pack which includes at least one surface and a plurality of cell holders inclined with respect to at least one surface. The cell holders have a size sufficient to hold respective battery cells inclined with respect to the at least one surface.

### CROSS-REFERENCE TO RELATED APPLICATION

Korean Patent Application No. 10-2016-0099081, filed on Aug. 3, 2016, and entitled, “Battery Pack,” is incorporated by reference herein in its entirety.

### BACKGROUND

### 1. Field

One or more embodiments described herein relate to a battery pack.

### 2. Description of the Related Art

Secondary batteries are chargeable and dischargeable. Low-capacity secondary batteries power small portable electronic devices such as cellular phones. High-power secondary batteries power the motors of electric bicycles, electric scooters, and electric vehicles. Examples of secondary batteries include prismatic secondary batteries, cylindrical secondary batteries, and pouch-type secondary batteries.

Secondary batteries often include a case containing an electrode assembly in an electrolyte solution. Electrode tabs and terminals of positive and negative electrodes are connected to the electrode assembly and are exposed or protrude through a cap plate.

In some cases, it may not be sufficient to use only one battery cell as a power source for a notebook computer, an electronically driven tool, an electric bicycle, an electric scooter, or other devices. Therefore, a battery pack has been developed to include a plurality of battery cells connected, in series and/or parallel, for providing greater power. Such a battery pack often includes a protective circuit module to control charge and discharge states of battery cells and to avoid various risks associated with over-charge or over-discharge.

One type of battery pack includes multiple 18650 size (18 mm in diameter, 65 mm in length) cylindrical battery cells connected to one another. Such a battery pack is manufactured to have a fixed size based on the 18650 size which cannot accommodate other size battery cells. Products employing such a battery pack may also be adapted to accommodate only the fixed 18650 size battery cells. Consequently, if the size and/or shape of the cylindrical battery cells change, existing battery packs and/or their host products cannot use them.

### SUMMARY

In accordance with one or more embodiments, a battery pack includes at least one surface; and a plurality of cell holders inclined with respect to at least one surface, wherein the cell holders have a size sufficient to hold respective battery cells inclined with respect to the at least one surface. The battery pack may include at least one bending tab to connect the battery cells to each other in series or parallel.

The bending tab may include at least one first connector electrically connected to one terminal surface of each of the battery cells and a surface inclined at a predetermined angle with respect to the at least one surface of the battery pack, and a second connector having a surface parallel with the first connector. The bending tab may include at least one first connector electrically connected to one terminal surface of each of the battery cells and having a surface inclined at a predetermined angle with respect to the at least one surface of the battery pack, and a second connector having a surface crossing at a predetermined angle to one surface of the first connector.

The bending tab may include a coupler between the first and second connectors. The coupler may be parallel with the at least one surface of the battery pack. The first connector may include a plurality of electrode connection tabs on different planes parallel with each other and a step coupler that couples the electrode connection tabs to one another, and the electrode connection tabs may be electrically connected to electrode terminal surfaces of respective ones of the battery cells. The electrode connection tabs may be arranged in a zigzag configuration. The battery pack may include a circuit board electrically connected to the bending tabs.

In accordance with one or more other embodiments, a battery pack includes a case; and a plurality of holders within the case, wherein the case has a size to accommodate battery cells of a first size and wherein the holders have a size to hold respective battery cells of a second size greater than the first size, the holders arranged to allow the battery cells to be aligned diagonally within the case. The holders may be aligned diagonally in the case. The battery cells may have a substantially cylindrical shape. The holders may have a substantially cylindrical shape.

The battery pack may include a plurality of conductive tabs within the case, wherein the conductive tabs electrically connect the battery cells. The battery cells and holders may be arranged in a first direction in the case, and at least two of the battery cells may overlap in a second direction different from the first direction.

### BRIEF DESCRIPTION OF THE DRAWINGS

Features will become apparent to those of skill in the art by describing in detail exemplary embodiments with reference to the attached drawings in which:

FIG. 1 illustrates an embodiment of a secondary battery;

FIG. 2 illustrates an embodiment of a battery pack;

FIG. 3 illustrates another view of the battery pack;

FIGS. 4A and 4B illustrate an embodiment of a bending tab;

FIG. 5 illustrates another embodiment of a battery pack;

FIGS. 6A and 6B illustrate another embodiment of a bending tab;

FIG. 7A illustrates another embodiment of a battery pack and FIG. 7B illustrates a view of the battery pack in FIG. 7A; and

FIGS. 8A and 8B illustrate additional embodiments of bending tabs.

### DETAILED DESCRIPTION

Example embodiments will now be described with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. The embodiments (or portions thereof) may be combined to form additional embodiments.

In the drawings, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

As used herein, the term “and/or” includes any and all combinations of one or more of the associated listed items. In addition, it will be understood that when an element A is referred to as being “connected to” an element B, the element A can be directly connected to the element B, or an intervening element C may be present between the elements A and B so that the element A can be indirectly connected to the element B.

In addition, the terminology used herein is for the purpose of describing particular embodiments only and is not intended to be limiting thereof. As used herein, the singular forms are intended to include the plural forms as well, unless the context clearly indicates otherwise. It will be further understood that the terms “comprise” or “include” and/or “comprising” or “including,” when used in this specification, specify the presence of stated features, integers, steps, operations, elements, and/or components, but do not preclude the presence or addition of one or more other features, integers, steps, operations, elements, components, and/or groups thereof.

It will be understood that, although the terms first, second, etc. may be used herein to describe various members, elements, regions, layers and/or sections, these members, elements, regions, layers and/or sections should not be limited by these terms. These terms are only used to distinguish one member, element, region, layer, and/or section from another. Thus, for example, a first member, a first element, a first region, a first layer and/or a first section discussed below could be termed a second member, a second element, a second region, a second layer and/or a second section without departing from the teachings.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below.

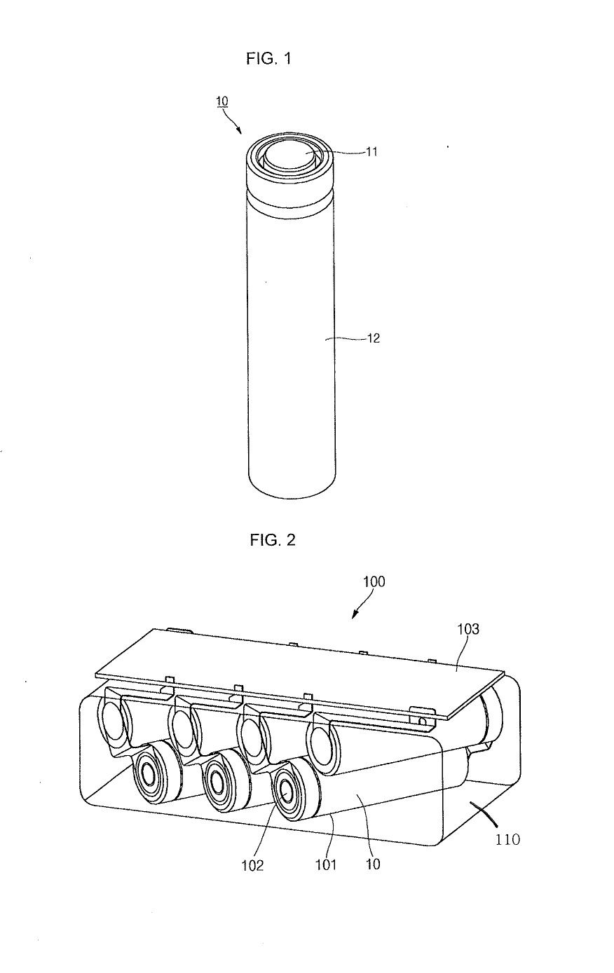

FIG. 1 illustrates an embodiment of a battery cell 10 which has a circular (or cylindrical) shape including first and second electrodes 11 and 12. In another embodiment, the battery cell 10 may be a different type or shape, e.g., a prismatic or a different type of circular battery cell. The battery cell 10 may be a rechargeable secondary battery and may have various shapes depending, for example, on the design of a battery pack.

The battery cell 10 includes a can 12 having an opening and a cap assembly 11, which seals the opening of the can 12. The can 12 has a bottom surface formed at a location corresponding to the opening. An electrode assembly and an electrolyte solution may be in the can 12. The electrode assembly includes a positive electrode plate, a negative electrode plate, and a separator between the positive and negative electrode plates wound in a predetermined (e.g., spiral) configuration. Electrode tabs made of, for example, nickel or copper, are respectively provided in the positive and negative electrode plates.

The electrode tab in the positive electrode plate is connected to the cap assembly 11. The electrode tab in the negative electrode plate is connected to the bottom surface of the can 12. Therefore, the cap assembly 11 may function as a positive electrode terminal and the can 12 may function as a negative electrode terminal. A gasket may be interposed between the cap assembly 11 and the can 12 to insulate the cap assembly 11 and the can 12 from each other. Electric energy generated by a chemical reaction between the electrode plates and an electrolyte solution is transmitted outside through the electrode plates.

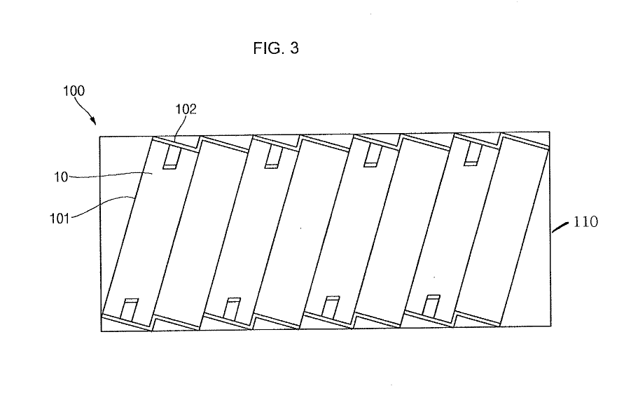

FIG. 2 illustrates an embodiment of a battery pack 100 which includes a plurality of battery cells 10. FIG. 3 illustrates a plan view of the battery pack in FIG. 2.

Referring to FIGS. 2 and 3, the battery pack 100 includes a case 110 and cell holder units 101 formed in a direction inclined with respect to a lateral surface of the battery pack 100. As a result, the battery cells 10 are inclined with respect to the lateral surface of the battery pack 100. Bending tabs 102 connect the battery cells 10 to each other in series or parallel. A circuit board 103 is electrically connected to the bending tabs 102 and is exposed outside the battery pack 100.

Each of the cell holder units 101 may be adapted to the size and shape of the battery cell 10, e.g., conform to the size and shape of the battery cell 10. For example, the battery pack 100 may be originally designed to accommodate one or more battery cells of a first size (e.g., 18650 size cylindrical battery cells) without being inclined within the case. In this embodiment, the cell holder unit 101 is designed to have a size sufficient to hold one or more battery cells of a second size, e.g., a new size of cylindrical battery cells such as 21700 size cylindrical battery cells. The 21700 size cylindrical battery cells are larger than 18650 size cylindrical cells in both diameter and length. Thus, in order to enable the battery pack 100 to be used in accommodating the larger 21700 size cylindrical battery cells, the battery cells 10 are inclined within the battery pack 100, for example, as in FIG. 3.

The cell holder unit 101 is adapted to the shape of the battery cell 10. Thus, the cell holder unit 101 may be fabricated to hold the battery cell 10 by making contact with only a portion of the battery cell 10. In one embodiment, the cell holder unit 101 may have a shape that corresponds to the bending tab 102, for example, in order to allow the bending tab 102 and the cell holder unit 101 to be coupled to each other. The conductive bending tab 102 may be attached to the cell holder unit 101, which, for example, may be made of plastic material.

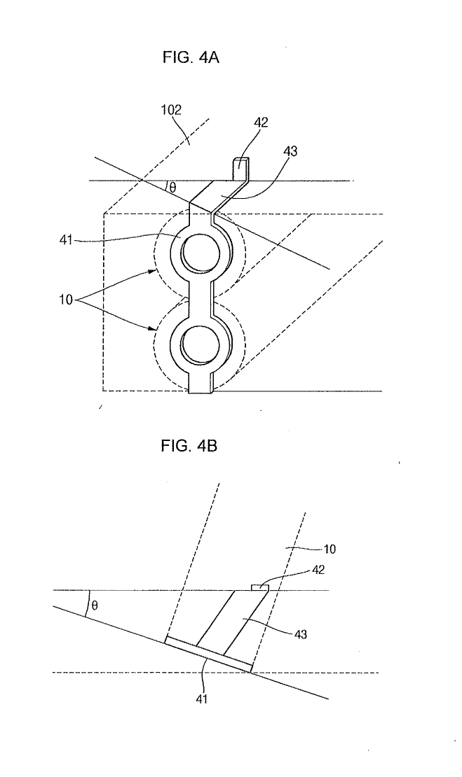

FIGS. 4A and 4B illustrate an embodiment of bending tab 102. For illustrative purposes only, the bending tab 102 in FIGS. 4A and 4B is illustrated to connect two vertical battery cells to a circuit board, rather than a structure of connecting multiple battery cells to each other.

The bending tab 102 includes first connection units 41, a second connection unit 42, and a coupling unit 43. The first connection units 41 are electrically connected to electrode terminal surfaces of the battery cells 10 and have surfaces parallel with the electrode terminal surfaces. In addition, the first connection units 41 are inclined at a predetermined angle θ with respect to a lateral surface of the battery pack 100.

The second connection unit 42 has a surface crossing the surfaces of the first connection units 41 by the predetermined angle θ. The second connection unit 42 has a surface parallel with the lateral surface of the battery pack 100. Therefore, in FIG. 2, the plurality of second connection units 42 are aligned on the circuit board 10 in a line, e.g., are linearly arranged. However, the second connection unit 42 may not necessarily be parallel with one surface (e.g., a lateral surface) of the battery pack 100 (e.g., one surface of the case 110) and may be formed at different angles in another embodiment.

The coupling unit 43 functions to connect the first connection units 41 and the second the connection unit 42. In one embodiment, the coupling unit 43 has a surface parallel with a top surface of the battery pack 100.

Referring to FIG. 4B, which illustrates the bending tab 102 viewed from above, the first connection units 41 are parallel with the electrode terminal surfaces to establish contact with electrode terminals of the battery cells 10. Since the battery cells 10 are fixed to the lateral surface of the battery pack 100 at the predetermined angle θ, the surfaces of the first connection units 41 are inclined with respect to the lateral surface of the battery pack 100 by the predetermined angle θ.

In addition, the second connection unit 42 is parallel with the lateral surface of the battery pack 100 and is inclined with respect to the first connection units 41 by the predetermined angle θ. In one embodiment, the coupling unit 43 is parallel with the top surface of the battery pack 100. In one embodiment, the coupling unit 43 may not be parallel with the top surface of the battery pack 100, for example, in order to save material for forming the bending tab 102 or to facilitate the manufacturing process.

The first connection unit 41 may include a plurality of electrode connection tabs, for example, based on the number of battery cells 10 connected to each other in series or parallel. For example, the electrode connection tabs may be on the same surface and may be positioned on different surfaces parallel with each other. When the battery cells 10 are connected to each other in series, the bending tab 102 electrically connects different electrode terminal surfaces of different battery cells 10. When the battery cells 10 are connected to each other in parallel, the bending tab 102 electrically connect the same electrode terminal surfaces of different battery cells 10.

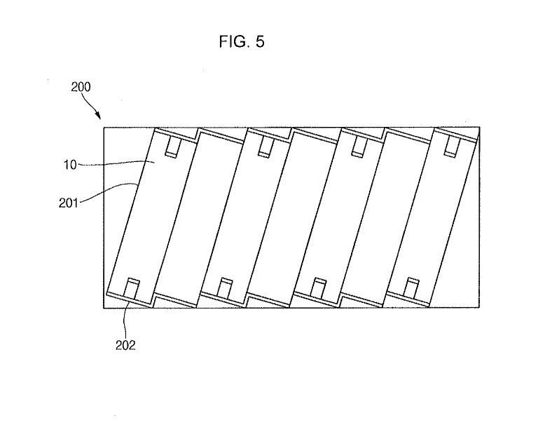

FIG. 5 illustrates a plan view of another embodiment of a battery pack 200 which includes cell holder units 201, bending tabs 202, and a circuit board like the battery pack 100 in FIG. 3. Like the cell holder units 101 in FIG. 3, the cell holder units 201 are inclined with respect to a lateral surface of the battery pack 200, so that battery cells 10 are inclined with respect to the lateral surface of the battery pack 200. In order to connect battery cells to each other in series or in parallel, the bending tabs 202 are arranged on the lateral surface of the battery pack 200 connect electrode terminals of the battery cells 10 to the circuit board. The bending tabs 202 may be different from the bending tabs 102 in FIG. 3 in that the bending tabs 202 are attached to the circuit board, so as not to be parallel to the lateral surface of the battery pack 200 but parallel to electrode surfaces of the battery cells 10.

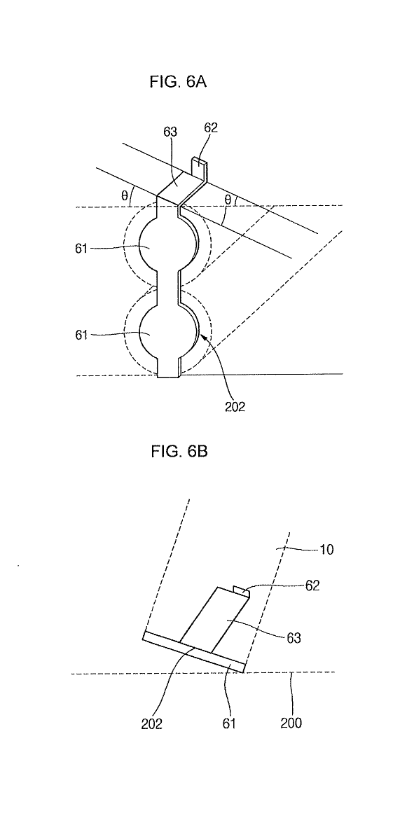

FIGS. 6A and 6B illustrate another embodiment of a bending tab 202 that connects two, vertically arranged, battery cells to a circuit board. Referring to FIGS. 6A and 6B, the bending tab 202 includes a first connection unit 61, a second connection unit 62, and a coupling unit 63. The first connection unit 61 is electrically connected to an electrode terminal surface of each of the battery cells 10 and has a surface parallel to the electrode terminal surface. The first connection unit 61 is inclined at a predetermined angle θ with respect to a lateral surface of the battery pack 200. In addition, the second connection unit 62 is formed on a surface parallel with the first connection unit 61. Therefore, the surface of the second connection unit 62 is also inclined at a predetermined angle θ with respect to the lateral surface of the battery pack 200. The coupling unit 63 connects the first connection units 61 and the second the connection unit 62. In one embodiment, the coupling unit 63 has a surface parallel with a top surface of the battery pack 200.

Referring to FIG. 6B, which illustrates the bending tab 202 viewed from above, the first connection unit 61 is parallel with the electrode terminal surface to establish contact with an electrode terminal of the battery cell 10. Te battery cell 10 is fixed to the lateral surface of the battery pack 200 at the predetermined angle θ. Thus, the surface of the first connection unit 61 is also inclined the with respect to the lateral surface of the battery pack 200 by the predetermined angle θ. The second connection unit 62 is parallel with the first connection unit 61 and inclined at the predetermined angle θ with respect to the lateral surface of the battery pack 200. In an embodiment, the coupling unit 63 is parallel with the top surface of the battery pack 200. In one embodiment, the coupling unit 63 may not be parallel with the top surface of the battery pack 200, for example, in order to save on the cost of materials of or to facilitate the manufacturing process.

The first connection unit 61 may include multiple electrode connection tabs, for example, based on the number of multiple battery cells 10 connected to each other in series or parallel. The electrode connection tabs may be on the same plane or may be on different planes parallel with each other.

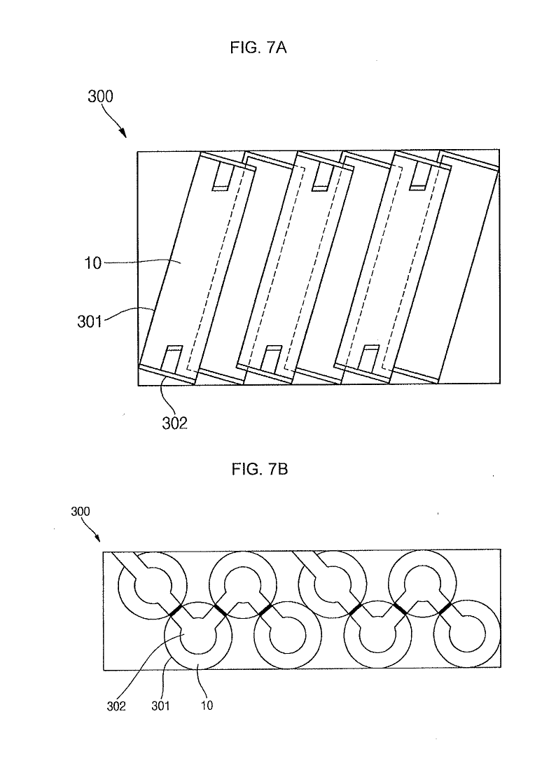

FIG. 7A illustrates another embodiment of a battery pack 300 and FIG. 7B illustrates a side view of the battery pack in FIG. 7A. Referring to FIGS. 7A and 7B, in order to efficiently stack the battery cells 10, which are cylindrical cells, the battery cells 10 are arranged in the battery pack 300 in a zigzag configuration. Like the cell holder units in FIGS. 3 and 5, cell holder units 301 of the battery pack 300 are inclined with respect to a lateral surface of the battery pack 300. Thus, the battery cells 10 are also inclined with respect to the battery pack 300.

The cell holder units 301 may be fabricated to accommodate the shapes of the battery cells 10. In one embodiment, the cell holder units 301 may be fabricated to contact only some of the battery cells 10 in order to hold the battery cells 10. In one embodiment, the cell holder units 301 may be coupled to bending tabs 302, which have a shape corresponding to the cell holder units 301. The bending tabs 302 have conductivity and may be attached to the cell holder units 301. The cell holder units 301 may be made, for example, of plastic material.

The inclination angle may be determined so that terminal portions of terminal surfaces of the battery cells 10 inclined with respect to at least one surface of the battery pack 300 contact internal lateral surfaces of the battery pack 300.

Referring to FIGS. 7A and 7B, the cell holder units 301 are arranged so that the battery cells 10 are in a zigzag configuration when laterally viewed from the battery pack 300. Since the battery cells 10 are inclined relative to the battery pack 300, first connection units 81 of the bending tabs 302 include electrode connection tabs on different planes. For example, the first connection units 81 of the bending tabs 302 include multiple electrode connection tabs, each having a step.

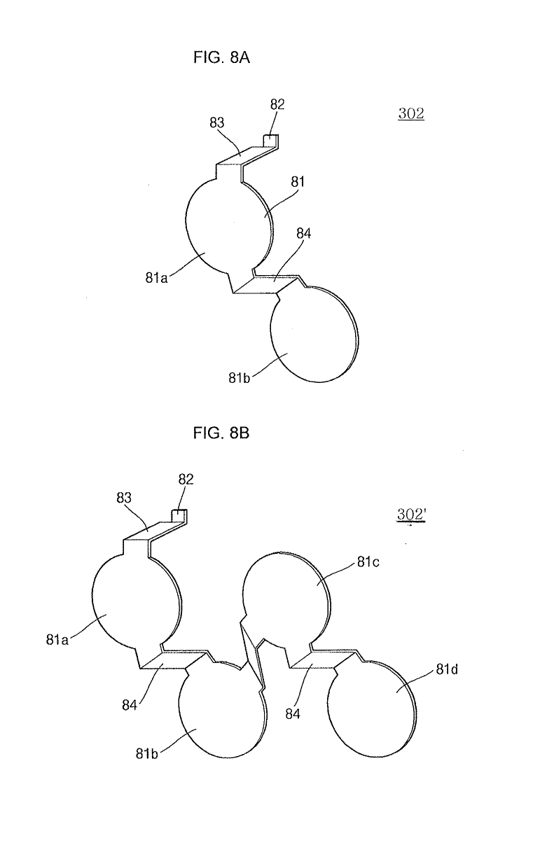

FIGS. 8A and 8B illustrate additional embodiments of bending tabs for a battery pack, for example, as illustrated in FIGS. 7A and 7B. Referring to FIGS. 8A and 8B, the bending tabs include bending tabs 302 and 302′, each of which includes a first connection unit 81, a second connection unit 82, a coupling unit 83 and a step coupling unit 84.

The first connection unit 81 is electrically connected to electrode terminal surfaces of the battery cells 10 and includes a plurality of electrical connection tabs (81a and 81b or 81a, 81b, 81c and 81d) on surfaces parallel with the electrode terminal surfaces. The first connection unit 81 is inclined at a predetermined angle θ with respect to a lateral surface of the battery pack 300. The electrical connection tabs 81a, 81b, 81c and 81d correspond to respective electrode terminals of the battery cells 10. Since the battery cells 10 are inclined with respect to the battery pack 300, the electrode terminals of the battery cells 10 are not on the same plane but are on different planes parallel with each other. Therefore, each of the electrical connection tabs 81a, 81b, 81c and 81d may include a step coupling unit 84, which electrically connects adjacent ones of the electrical connection tabs 81a, 81b, 81c and 81d.

In accordance with one or more of the aforementioned embodiments, a battery pack allows a different or new size battery cell to be used with a battery pack, designed to accommodate another (e.g., existing) size battery cell, without changing the design of the battery pack or a host product, e.g., an electronically driven tool designed so as to be adapted to the size of the existing battery pack.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the embodiments set forth in the claims.

What is claimed is:

1. A battery pack, comprising:
at least one surface; and
a plurality of cell holders inclined with respect to at least one surface, wherein the cell holders have a size sufficient to hold respective battery cells inclined with respect to the at least one surface.

2. The battery pack as claimed in claim 1, further comprising at least one bending tab to connect the battery cells to each other in series or parallel.

3. The battery pack as claimed in claim 2, wherein the at least one bending tab includes:
at least one first connector electrically connected to one terminal surface of each of the battery cells and a surface inclined at a predetermined angle with respect to the at least one surface of the battery pack, and
a second connector having a surface parallel with the first connector.

4. The battery pack as claimed in claim 2, wherein the at least one bending tab includes:
at least one first connector electrically connected to one terminal surface of each of the battery cells and having a surface inclined at a predetermined angle with respect to the at least one surface of the battery pack, and
a second connector having a surface crossing at a predetermined angle with respect to one surface of the first connector.

5. The battery pack as claimed in claim 4, wherein the at least one bending tab includes a coupler between the at least one first connector and the second connector.

6. The battery pack as claimed in claim 5, wherein the coupler is parallel with the at least one surface of the battery pack.

7. The battery pack as claimed in claim 5, wherein:
the at least one first connector includes a plurality of electrode connection tabs on different planes parallel with each other and a step coupler that couples the electrode connection tabs to one another, and
the electrode connection tabs are electrically connected to electrode terminal surfaces of respective ones of the battery cells.

8. The battery pack as claimed in claim 7, wherein the electrode connection tabs are arranged in a zigzag configuration.

9. The battery pack as claimed in claim 2, further comprising:
a circuit board electrically connected to the bending tabs.

10. A battery pack, comprising:
a case; and
a plurality of holders within the case,
wherein the case has a size to accommodate battery cells of a first size and wherein the holders have a size to hold respective battery cells of a second size greater than the first size, the holders arranged to allow the battery cells to be aligned diagonally within the case.

11. The battery pack as claimed in claim 10, wherein the holders are aligned diagonally within the case.

12. The battery pack as claimed in claim 10, wherein the battery cells have a substantially cylindrical shape.

13. The battery pack as claimed in claim 12, wherein the holders have a substantially cylindrical shape.

14. The battery pack as claimed in claim 10, further comprising:
a plurality of conductive tabs within the case,
wherein the conductive tabs electrically connect the battery cells.

15. The battery pack as claimed in claim 14, wherein:
the battery cells and holders are arranged in a first direction in the case, and
at least two of the battery cells overlap in a second direction different from the first direction.
